(19) United States
(12) Patent Application Publication
(10) Pub. No.: US 2009/0092943 A1
(43) Pub. Date: Apr. 9, 2009

(54) METHOD FOR MANUFACTURING METAL WITH CERAMIC COATING

(76) Inventor: Shoshana Tamir, Haifa (IL)

Correspondence Address: Pearl Cohen Zedek Latzer, LLP, 1500 Broadway, 12th Floor, New York, NY, 10036, US

(21) Appl. No.: 12/281,742

(22) PCT Filed: Mar. 5, 2007
(86) PCT No.: PCT/IL07/00277

§ 371 Date: Sep. 4, 2008

Related U.S. Application Data
(60) Provisional application No. 60/778,922, filed on Mar. 6, 2006.

(51) Int. Cl. A61C 13/08; C25D 13/12; C25D 13/02; A61C 13/225

(52) U.S. Cl. 433/172; 204/478; 433/217.1

(57) ABSTRACT

A method for manufacturing a coated implant, the method comprising depositing in electrophresis at least one ceramic layer on at least a portion of the body of the implant; and sintering said at least one ceramic layer using optical radiation.

### FIELD OF THE INVENTION

The present invention relates to ceramic coatings, and particularly, but not limited to, an implant (such as dental implant) with ceramic coating and method of producing it thereof, using a multi step process, which involves electrophoretic deposition and laser sintering techniques.

### BACKGROUND OF THE INVENTION

Dental implants are used as a foundation for false teeth construction. As the implants are in contact with different tissues of the pharynx, such as the palate tissue and the bone tissue, optimal biocompatibility between the implants surface and the different tissues is necessary. In addition, dental implants are exposed to pharynx surroundings and therefore it is also necessary that the dental implants surface, which is exposed to these surroundings, would be durable and plaque-free. Nowadays, many studies are being carried out to improve dental implants, mainly in order to shorten the period of the healing time and to improve the quality of the implant absorption in the human mouth.

Typically, dental implants are made of pure Titanium, but there are implants, which are made of Titanium alloys, such as Ti-6Al-4V alloy. Although special reference is made to pure Titanium throughout this specification, the present invention is not limited to pure Titanium and also covers implants made from titanium alloys. The present preparation process of dental implants is based on mechanical processing of the Titanium in order to produce two mechanical parts: a screw anchor (also referred to as “implant”, see FIG. 1) that is implanted into the jaw bone, and a screw portion with a cap (also referred to as “abutment” or “suprastructure”, see FIG. 1), which tops the anchor. As mentioned above, an important concern in producing body implants is the interface between the implant and live body tissue. This interaction determines the success rate of the implant and the influence on the implant function for time to be. Following the above, many studies were conducted on the biological reaction of the implants, and also on the influence of different implant surface treatments on the quality of the implant, and it is now established that surface treatment directly influences the interaction between the implant and the live tissue.

Implants incorporating an implant body incorporating titanium (or alloys) and ceramics are known:

For example, in US2005181330, there is disclosed an abutment of a dental implant consisting of an abutment screw and a shoulder surface. The upper structure of a crown or bridge abutment, i.e., the abutment screw is made of titanium alloy, and surface-treated in brown color by an anodizing process, and the connecting structure thereof, i.e., the shoulder surface is made of ceramic material containing zirconia of a white color, thereby providing an adequate mechanical strength, while maintaining the natural color of human teeth and light permeability.

In FR2765095 there was disclosed an implant consisting of a shank with a tip designed to be screwed into the jaw, a smooth intermediate trans-mucous section and a conical end connected to a tool mandrel. The implant can be made from a suitable ceramic material or a metal such as titanium, e.g. alloyed with niobium, tantalum and zirconium, a chrome-cobalt alloy, or a medical grade stainless steel with a surface coating or treatment by plasma or ceramic coating, e.g. with silica or hydroxyapatite.

In U.S. Pat. No. 5,993,214 there was disclosed a method for the manufacture of a product such as a dental product or product intended for use in the human body and comprising a substructure of titanium or equivalent tissue-compatible material and intended for coating with a ceramic onlay material.

US 2004191727 deals with an implant which is one embodiment includes a ceramic coated surface.

Applying ceramic coating on metal was described in DE102004041687, where a method of producing bond between titanium and dental ceramic involves ion implantation onto Titanium surface and burning on of ceramic was discussed. The method of producing a bond between titanium and ceramic for dentistry involves a PVD or CVD discharge or a plasma-ion implantation and removal so that zirconium molecules are attached to and into the titanium surface to define a zirconium oxide layer. A dental ceramic can be coated and burned onto the oxide layer.

JP2021858 was aimed at improving durability, gloss of the surface and the appreciation of the beauty of the crown or the like by applying one or more kind chemical compounds selected from alkali metal salt, oxides, hydroxides and metal alkoxides of one or more metals selected from a group comprising Si, Al, Ti, Zr, Mg and Ce to the surface of an artificial tooth, and then heat-treating same. The cited chemical compounds are alkali metal salt such as alkali silicate, and its hydrate, oxides such as silica and the like, hydroxides such as titanium hydroxide and the like, various sol and gel of oxide and hydroxide, and various metal alkoxides such as methoxides, butoxides of metals, i.e., Si, Al, Ti, Zr, Mg, Ce. One, two or more kinds are selected from the above, and formed into a solution or suspension with a suitable solvent such as water, methanol or the like. The solution or suspension is applied to the surface of the ceramic or metallic crown by brushing or spraying method. After such application, when the crown is subjected to heat treatment at 100-1000 deg. C. by a heating device such as an electric furnace, a strong coat is formed on the surface of the base material.

It is an object of the present invention, to provide a dental implant with ceramic coating on the surface of the upper part of the implant, in order to increase and improve biological compatibility of the implant with the surrounding gum tissues, and also to increase implant durability to the pharynx surroundings. In addition, the present invention is aimed at improving the aesthetic appearance of the implant. The ceramic coating matches the appearance of natural teeth better than metallic implant, and also allows control of the coloring.

Deposition of ceramic coating on a Titanium substrate, according to a preferred embodiment of the present invention, is performed by applying electrophoresis followed by laser sintering. Commercial Zirconia powder and dental Alumina powder, which comprises Zirconia in different concentrations, were used in the process of electrophoretic deposition. Moreover, experiments revealed that addition of dental glass to the dental Alumina and Alumina-Zirconia improved the results of the laser sintering process.

An application of an electrophoretic precipitation in coating dental crowns and bridges is the subject of U.S. Pat. No. 4,246,086. This patent refers to applying an opaque layer of base mass and subsequently a layer of dentine to a base blank consisting of precious metal or Nickel alloy. Application of Electrophoretic Deposition (EPD) as a method of depositing Calcium Phosphate ceramics onto metal surfaces, serving as a bone implant device, is the subject of U.S. Pat. No. 4,990,163 and U.S. Pat. No. 5,258,044. Accordingly, EPD materials and EPD methods described in these patents are aimed at promoting bone tissue ingrowth. Application of EPD to fabricate small, precisely shaped ceramic bodies is the subject of U.S. Pat. No. 5,919,347 and the usage of EPD for fabricating dental appliances is the subject of U.S. Pat. No. 6,059,949. These patents refer to fabricating small, precisely shaped ceramic bodies, especially dental appliances, such as crowns, artificial teeth and bridges, as opposed to the present invention, which concerns coating of implants and dental appliances. In addition, it should be pointed out that all the foregoing patents involve conventional oven sintering processes, if at all.

The main obstacle in using EPD is the existence of many uncertainties regarding the sintering process due to the limitation of the sintering temperature. Sintering of dental powders requires temperatures over 1400° C. These high temperatures influence the material contraction. Furthermore, when coating of metallic materials is concerned, it is known that most of the metallic materials are not durable under these temperature conditions. Titanium is particularly sensitive to heating and its structure is changed when exposed to high temperatures, even below 900° C.

Thus, conventional sintering in a furnace, in air or in vacuum, was found unsuitable for the present invention. Furnace sintering in a temperature around 1500° C. causes to oxidation of the Titanium and as a result a yellow shade on the coating is observed. In vacuum sintering of a ceramic coating with a thickness of around 20 microns, a chemical reaction occurred between the Titanium and the Alumina, therefore the white coating received a gray shade. Thicker coatings may be considered, in order to preserve the white color of the coating, but are prone to cracks. Laboratory experiments performed by the inventors showed that a complete sintering of the ceramic coating, without any damage caused to the metallic substrate, can be achieved by laser sintering

The process of deposition is simple to perform, but it requires skill and knowledge acquired along many years in choosing the composition of the suspension and the way to prepare it in order to obtain good results. The deposition process is also very competitive with other coating methods, especially with reference to different forms of the metallic basis.

Laser sintering process is comparatively new, although it is used nowadays to build models and prototypes of ceramic materials. The use of laser for sintering presents a scientific challenge. As opposed to conventional methods, in laser sintering local heating is achieved using an optical source. The use of laser broadens greatly the variety of products, as it is possible to control the sintered area and the depth of thermal diffusion. There is a broad variety of lasers in the market for processing materials and there is much experience in using these lasers.

The two main parameters, which occupy nowadays the world of dental implants, are the fast healing of the patient and the aesthetic appearance after the implantation and the rebuilding of the tooth. Ceramic coating of the upper part of the implant seems to be the answer to these problems. Ceramic coating improves the aesthetic appearance by color resemblance to the natural color of the tooth, as opposed to the undesired gray color of Titanium. In addition, ceramic coating decreases the risk of infection of the implant by germs present in the pharynx, thus allowing fast healing of the treated area. Ceramic coating has high durability under the anticipated chemical and biological conditions in the pharynx. Ceramic coating possesses mechanical qualities of hardness, and erosion durability, and is also durable under the influence of the fluids, which exist in the pharynx, which cause corrosion and dissolution of metals.

### SUMMARY OF THE INVENTION

There is thus provided, in accordance with some preferred embodiments of the present invention, a method for providing ceramic coating on a surface of a metal, comprising:

depositing in electrophresis at least one ceramic layer on the metallic surface; and

sintering said at least one ceramic layer using optical radiation.

Furthermore, in accordance with some preferred embodiments of the present invention, the metal comprises titanium.

Furthermore, in accordance with some preferred embodiments of the present invention, the metal comprises titanium alloy.

Furthermore, in accordance with some preferred embodiments of the present invention, the surface comprises at least a portion of a surface of an implant.

Furthermore, in accordance with some preferred embodiments of the present invention, said implant is a dental implant.

Furthermore, in accordance with some preferred embodiments of the present invention, said portion of the implant body is a portion that is not to be in contact with a bone.

Furthermore, in accordance with some preferred embodiments of the present invention, the optical irradiation comprises laser radiation.

Furthermore, in accordance with some preferred embodiments of the present invention, the ceramic layer comprises a mixture with one or more metallic materials.

Furthermore, in accordance with some preferred embodiments of the present invention, the ceramic coating comprises metal selected from a group of metals consisting nickel, aluminium.

Furthermore, in accordance with some preferred embodiments of the present invention, there is provided an implant device comprising: an implant body; ceramic coating on at least a portion of the implant.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates a general view of a ceramic-coated implant, in accordance with a preferred embodiment of the present invention, in assembled and disassembled states.

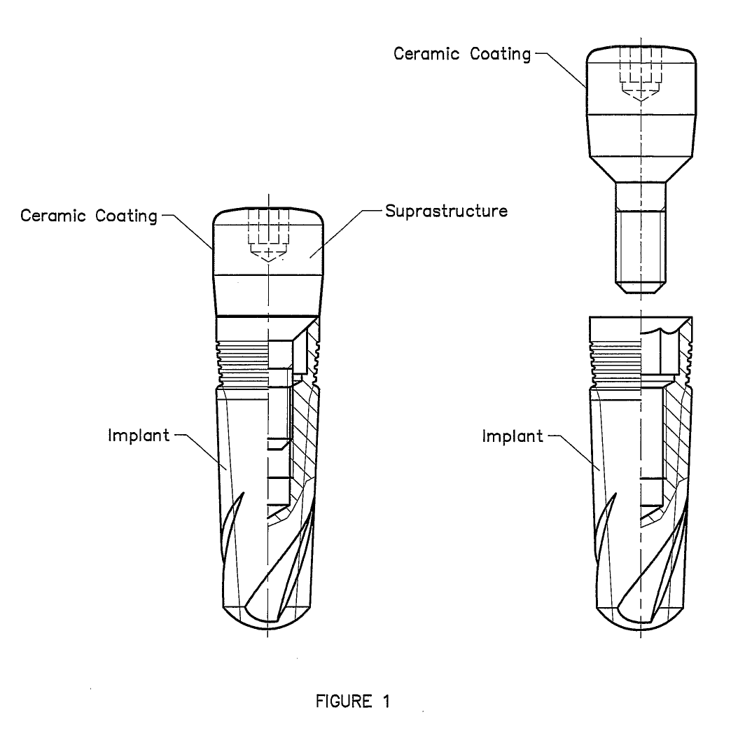

FIG. 2 is a flow chart describing the main stages of a method of producing a ceramic-coated dental implant, according to a preferred embodiment of the present invention.

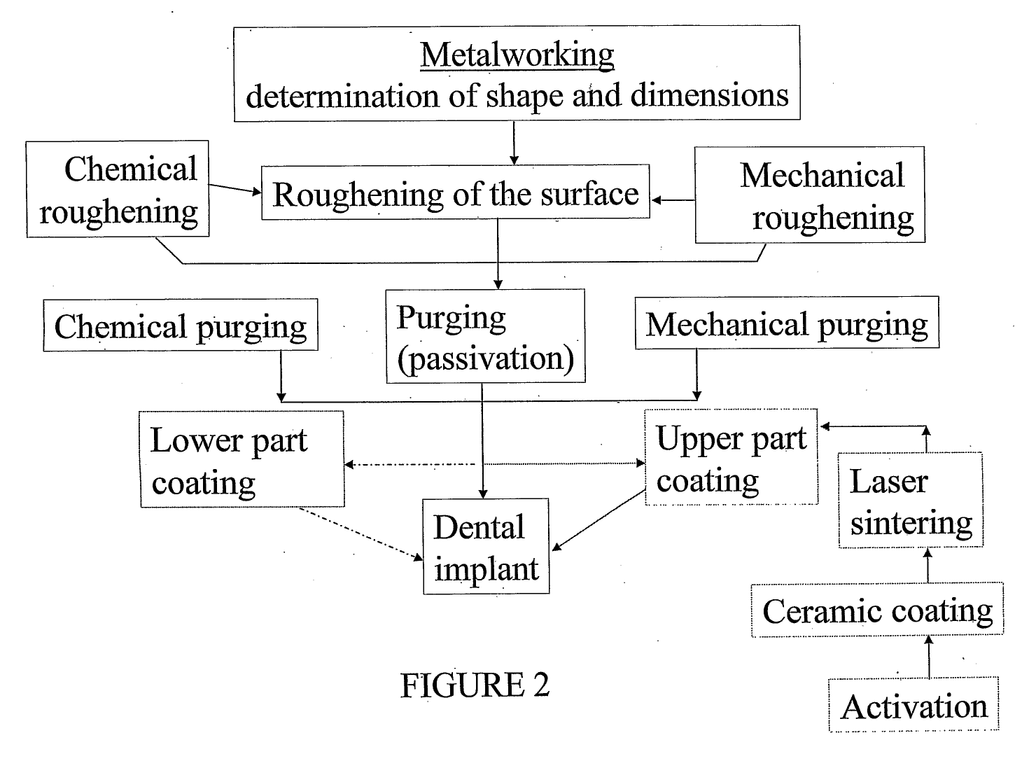

### DETAILED DESCRIPTION OF PREFERRED EMBODIMENTS

The present invention deals with ceramics coating, particularly of implants (but not limited to implants) and method of manufacturing thereof.

Although special reference is made to dental implants throughout this specification, the present invention is not limited to dental implants and covers other types of implants too, as well as other objects made of metal or having metallic surfaces. The method described below is also suitable for coating metals and alloys other than Titanium and Titanium alloys. In addition, all kinds of ceramic materials may be used for coating, and also other types of material can be used for coating, and such as polymers, metals and different mixtures of these materials.

A main aspect of the present invention is the provision of a dental implant that is constructed from (at least) two phases: a main screw body, which is commonly made of Titanium (or titanium alloy or other metal or metals), and comprises a bottom portion which is screwed into a bone or tissue, a top portion which serves as an interface for connecting it to a dental appliance such as a crown or other supplementary covering, and ceramic coating, which covers at least the top portion—hereinafter referred to as “cap”.

Generally, the method of manufacturing of implants includes a few phases that are discussed hereinafter.

First, metalworking is done, which is executed on all the implant parts, in order to receive the required form

Roughening of the surface of the lower part of the implant, which is to be in direct contact with the bone tissue, is then carried out, in order to form good bonding with the bone, while at the surface of the implant portion, which is in contact with the gums, the surface is relatively smooth. Implants supplied by different manufacturers possess different levels of roughness. The roughness of the external surface of a Titanium implant has great importance in determining the quality of the implant and the reaction to live tissue. Roughening of the implant surface or perforating it improves the bonding between the implant and the bone while interfacing. There are different treatments designated to increase the roughness or to perforate the surface, however, one way or the other, it is required in these treatments to maintain the Titanium durability in order to decrease, as much as possible, the quantity of the Titanium that is released to the tissue surrounding the implant. Implants provided by different suppliers of the above-mentioned different groups, were tested, and were found to be very different in the roughness level of their surface. Overly high roughness level can cause vast Titanium absorption by tissues that are adjacent to the implant and cause significant decreasing of the implant stability. In order to ensure the implant durability for a long period of time, it is necessary to characterize the ideal roughness level, the roughness form and other parameters. Popular treatments for changing the roughness level are based on sprayed Alumina particles and/or on chemical processes. In a comparison study of the roughness level of surfaces subjected to laser radiation, mechanical roughening, Titanium spraying, and Alumina spraying, accompanied by alkali/acidic treatment, it was found that the less polluted surfaces were the surface that underwent mechanical roughening and the surface that underwent laser treatment. Two roughening processes that are indicated in the literature for better texturing of a titanium surface are laser treatment and plasma spraying.

Passivation (optional) and purging processes are preferably performed on the whole implant. Executing these processes on the lower part of the implant, which interacts with the bone, occasionally cause a change in the roughness level of the implant surface. The purging processes include treatments for removing oxides and contaminants from the surface using acids and bases, causing a change in the chemical composition of the surface. A treatment of polished models of Titanium, that were treated using different procedures, including purging with Phosphoric acid and/or Nitrous acid and/or sterilization, caused a creation of oxides on the surface. The oxides on the surface were particularly TiO2 and a bit of TiO3. In addition, laser radiation of implant surface is being studied in order to purge the surface from contaminants.

Indication and coloring processes are usually performed on the upper part of the implant, which interacts with the gums and protrudes outside of them. Processes designated to create colored anodization of Titanium are particularly used for marking.

Sterilization processes are also performed on the whole implant.

Coating processes, which are optional, are performed particularly on the lower part of the implant, which comes in contact with the bone. Coatings of implants may comprise Hydroxyapatite and Calcium Phosphate. These processes are performed in order to increase durability of the implant in the presence of surface corrosion, and to improve biological activity of the surface. The creation of Calcium Phosphate or Apatite on the surface produces a layer, which is similar in its composition to a bone, and by that increases biological compatibility of the implant.

Layers of Hydroxyapatite (henceforth: “HA”) on the surface of implants can be deposited in various techniques, such as plasma spraying, spraying, electrolysis and electrophoresis. A main disadvantage of these techniques is the strong bonding of the HA to the bone which often leads to separation between the HA coating and the metallic implant, followed by loss of contact between the implant and the bone. HA deposition may be achieved by dipping the implant in a synthetic body fluid in a process imitating a natural process after activation of the surface. In a simple chemical process of dipping, a layer of Calcium Phosphate can be deposited on the Titanium surface. Nowadays, the use of PLD (Pulsed Laser Deposition) technique is being studied in order to create Calcium Phosphate and HA coatings. The advantage of PLD over the plasma spraying process lies in the creation of a crystalline layer, which has optimal stoichiometry, without the need of any other phase of hydration, which is customary with plasma treatment.

In addition, bioactive materials, which are able to create a biological bonding with solid and soft tissues, are currently being developed. The most studied materials are bioactive glasses and bioactive glass-ceramics, since these materials possess controlled field activity and adhere well to the bone. These coatings are deposited on the lower part of the implant. When these materials make contact with biological fluids, they produce a deposition of an Apatite layer from the solution. Titanium alloys can be coated by bioactive glasses using different methods, such as conventional enameling, spraying techniques and plasma spraying in vacuum. The different spraying methods are expensive and create problems because of the complex form of the implant, while the enameling method is cheaper and more appropriate for complex forms. This method is also suitable for the specific softening qualities of these materials. Bioactive glasses and bioactive glass-ceramics are used as substitutes for HA. In one research, two different layers of coating were used, an inner, softer layer, and an external, more solid layer, in order to prevent oxidization of the Titanium in the burning process. After dipping the ceramic materials in sludge, a burning process was carried out for a few seconds. The thickness of the produced coating of every layer is over 100 microns. Additional processes for creating a thick layer of oxide by using an oxidization process of dental implants surface include combinations of chemical processes and thermal treatments. Furthermore, coatings of Titanium Nitride on the surface of implants were carried out, which increased the resistance of implants to erosion.

It is pointed out that one must prevent accumulation of pathogenic bacteria at the implant neck area, and one of the ways to achieve that is to ensure that the implant neck is polished and smooth. It was found in a study (M. Yoshinari et al., Materials Transactions, Vol. 43, No. 10 (2002) 2494-2501) that Ca—P coating and other coatings, increase adhesion of the bacteria as opposed to polished Titanium, whereas Alumina coating, and implantation of F+ions in the area that makes contact with the soft tissues, decrease the expansion of the bacteria on the surface as opposed to polished Titanium.

As described above, the upper part of the implant makes contact with the gums and is exposed in the pharynx.

The process of creating ceramic coating is typically composed of four main stages. Stage one is pretreatment, i.e. preparation of the surface, which is designated to coating, by performing purification and activation processes upon it. Stage two is the process of coating using electrophoretic deposition. Stage three is dehydration process, and stage four is sintering process using a laser radiation.

A coating aiming to the objectives of the present invention should follow the next requirements: a uniform thickness (a typical range of 20 to 200 microns is reasonable for most purposes), maintain good adhesion between the platform and the coating, suitable appearance (white spectrum color and smooth glossy surface), and mechanical durability.

The main critical parameters in producing ceramics coated implants are: control over the coating composition, control over the radiation process and maintaining a good adhesion between the coating and the substrate. The composition of the coating depends on the suspension composition and on the deposition conditions, thereof depends on numerous parameters, such as: composition and concentration of additives, composition and size of powder particles and hydrodynamic conditions of suspension and the electric field. One of the most important factors in controlling the radiation process is the distribution of the laser intensity in the section of the encountering beam. In order to achieve good controlling over the heating and sintering process, one must ensure homogeneity of the laser beam. Since the goal is not to harm the metallic basis, during the laser radiation process, the ceramic material should be the only matter to be heated. Application of laser causes an activation of mechanical force over the coating, and as result of that causes strains, which might disconnect the coating from its substrate. Local heating causes insertion of strains to the ceramic coating and some times to the substrate as well, that due to differences in thermal expansion coefficients between the metal substrate and the ceramic material. The effect of the aforementioned phenomenon is appearance of cracks on the coating and/or delamination of the coating from the platform.

Electrophoretic coating is carried out by subjecting metallic substrate which is immersed in a suspension to an electric field. It is possible to deposit, in this manner, metallic and ceramic powders by charging the particles. Therefore, the electrophoretic coating process is depending on and characterized by the following parameters: the composition of the suspension, the time of deposition, the intensity of the electrical field and the thickness of the coating.

A suspension comprises a fluid of organic or aquatic base, ceramic particles and various additives, are being used in the electrophoretic deposition process. The composition of the suspension and the way it is prepared are extremely significant parameters in developing the deposition process. For preparation of the suspension from organic liquids, materials with dielectric coefficient between 12 and 25 are typically used, e.g., alcohols like isopropanol and ethanol. The ceramic powder, which is used for the deposition, is usually put through a long milling and a sonication in order to obtain small particles, and in order to enhance the charging of the surface of the particles, which are immersed in the suspension. Furthermore, materials, which cause dispersion and stability of the suspension, and additives, which create binding between the particles that build the coating, and which create the particle surface charge, are added to the suspension. The deposition rate depends on the powder concentration in the suspension, the electrical field and the charge of the particles. The thickness of the coating, under defined conditions, depends on the coating time.

Ceramic materials are widely used in the dental industry. In the manufacturing process of ceramic coated implants, according to the present invention, powders of ceramic materials, which were developed for the dental industry, are used, especially materials which were developed for crowns. Also commercial ceramic powders, which were developed for others applications (not for dental applications) were used in the present invention. The materials to be used should preferably be chemically durable, possess biological compatibility, aesthetic, high mechanical strength, fracture tolerability and be processable. Fracture toughness and mechanical strength are mechanical qualities, which are required in order to render the fragile ceramic material durability under strain and prevent fractures. Ceramic materials would fail if micro-fractures, which exist in the material, would expand under strain. Dental ceramic material must shrink as low as possible,(there is always a shrinkage) in order to prevent deformities. There are ceramic powders in the market, which are designated for dental crowns fabrication. It is possible to make from these powders crowns with high strength and high tolerability to fractures. Ceramic powders are usually based of Alumina, Alumina zirconia, and glass materials which are based on Alumina, such as: In-Ceram, Hi-Ceram and Vitadur N (Vita Zahnfabrik of Bad Sackingen, Germany), IPS Empress (Ivoclar—Vivadent), Procera AllCeram (Nobel Biocare), Dicor glass-ceramic (mica glass, Corning Glass Co. of Corning, N.Y.). The ceramic coating designed to coat the cap on the implant may also contain metals or other materials, for example Ti base alloys and alumina.

Zirconia ceramics are advantageous over other ceramic materials because of their excellent mechanical qualities and especially because of their high endurance against fractures. Adding glass decreases the sintering temperature, however, it was found by the inventors, that in order to obtain a ceramic material of good quality using an electrophoretic deposition and a vacuum furnace sintering, it is preferable to perform multi-layer coating of Alumina layers and glass layers.

The advantages of electrophoresis process upon other ceramic coating processes are, inter-alia, the ability to deposit powder of any kind, the simple control of the coating thickness, the broad range of thickness, from a few microns up to millimeter, high deposition rate, possibility of attaining complex shapes according to the structure of the platform, low cost of the equipment and possible automation.

After the electrophoretic deposition process, the damp coating goes through dehydration in a dessicator, in air and in a drying furnace. The dehydration process is a function of the temperature and the time period of the drying. Following that, sintering has to be performed.

Sintering ceramic materials requires heating up to high temperatures, usually over 1500° C. Therefore, the use of this method to create ceramic coatings is much limited due to the limitation on the possible pairing of metal and ceramics. In selecting the abovementioned pair one must consider the melting temperature differences of the two materials and ensure that it does not exceed 300° C. in order to allow fall sintering of the coating with no interaction with or impact on the metal basis. In addition, there is a great difficulty in preventing cracks in furnace sintering because of great differences in the thermal expansion coefficients of the metal and the ceramics. Sintering a ceramic material with no interaction with the titanium substrate was achieved in experiments, which were performed by the inventors, in carbon dioxide laser radiation. Thus, laser sintering complete the above described technology, since up to now electrophoretic deposition couldn't be implemented in production of coatings due to the inability to sinter the coating while maintaining the metallic substrate.

For a given size of thickness of coating, the following conditions for a laser sintering process must be set: atmosphere of Argon, Nitrogen or air, laser intensity and the velocity of the scanning. An important factor in controlling laser radiation is the intensity distribution of the laser in a section of the incident beam. In order to obtain good control over heating and sintering, it is necessary to ensure the homogeneity of the laser beam.

### EXAMPLES

### Example 1

Pretreatment: Preceding the performance of the EPD process, a pretreatment procedure of Titanium samples (i.e. flat and cylindrical specimens of Titanium, henceforth: “the samples”) was performed comprising the following steps:
1. Cleaning: the samples were cleaned by immersion in acetone in ultrasonic bath.
2. Degreasing: the samples were immersed in a bath containing 25 gr/l Na₃PO₄×12H₂O at about 80° C. for 3 minutes.
3. Rinsing in hot (about 80° C.) deionized water.
4. Rinsing in deionized water at room temperature.
5. Etching in bath containing 5 ml HF (40% vol.), 35 ml HNO₃ (70% vol.) and 60 ml H₂O at room temperature for 5 minutes.
6. Rinsing in deionized water at room temperature.
7. Rinsing in isopropanol.

### Electrophoretic Deposition:

In this example, an EPD coating of two layers was performed. First layer comprising EPD deposition of Zirconia dental powder and second layer comprising EPD deposition of Zirconia glass dental powder. The coating procedure consists of the following steps:
1. Suspensions preparation: Preparation of two EPD baths that contain the following types of dental powders: one, Vita In ceram zirconia, and the other Vita-In ceram zirconia glass (mixture of Zirconia and Zirconia glass of ratio: 3 to 1) (manufactured by VITA Zahnfabtik, Germany).
1.1 The received powders were subjected to a dry ball milling [“powder a” (the Zirconia powder)—48 h, and “powder b” (the Zirconia glass powder)—48 h].
1.2 Immersion in a bath containing isopropanol (powder a concentration 25 gr/l, powder b concentration 50 gr/l), and wet ball milling for 3 hours (for both powders).
1.3 Addition of additives: 1.5% of AcAc.
1.4 Sonication for 12 minutes in a 600 watt vibra-cell ultrasonic disintegrator VC600,from Sonicand Materials, USA.
2. Immersion of samples after pretreatment in the EPD baths that were prepared according to the procedure described in paragraph 1, first in the bath containing “powder a” and then in the bath containing “powder b”.
3. Current supply by electric field of intensity 50V/cm for the Ti samples using platinum anode. The sample is connected as a cathode.
4. The deposition time for the first layer (deposition of “powder a”): 20 sec and for the second layer (deposition of “powder b”): 40 sec.

Dehydration: after EPD the samples are inserted into a desicator. A beaker containing a solution of 90% isopropanol and 10% glycerin is put into the desicator. The samples are dehydrated in the above described manner for 72 hrs.

Laser Sintering: the sintering process is done by irradiation of the coated samples. The laser used for sintering is CO2 laser (wavelength of 10.6 micron), The laser diameter was 10 mm and the laser power is chosen to be 1000 watts. The coated sample subjected to the irradiation is mounted inside a chamber in Ar atmosphere for protecting the Ti samples from oxidation, during laser irradiation. The Ar gas flows continuously during laser sintering. A block of copper is attached to the samples as a mounting stage inside the reaction chamber in order to cool the samples. Irradiation speed is 5000 mm/min.

The materials, quantities and parameters described with reference to the examples given hereinabove are by no way limitations to the present invention, and are given by way of example only.

It is possible to create one or more coatings using the EPD process.

Ti—Al—V or any other suitable Titanium alloys samples might be used as well.

In the pretreatment stage, the rinsing can be made also in Ethanol.

The powders to be deposited by EPD process can be one or more of the following types of dental powders and commercial ceramics: Vita In ceram zirconia, Vita-In ceram zirconia glass and Vita-In ceram alumina (manufactured by VITA Zahnfabrik, Germany) and TZ-3T-E Zirconia (manufactured by TOSOH, Japan)

The dry milling should be performed upon the powders during at least 20 hr.

The immersion can be in a bath comprising isopropanol or ethanol, while the powder concentration should be at least 25 gr/l. A concentration less than that can be used if parameters like electric field voltage and deposition time are changed accordingly.

Variety of additives, which are acceptable to add when performing Electrophoresis, can be added to the suspension to be deposited, and such as: AcAc, CTAB, CTAB+PAA, PVB and Phosphate ester.

The duration of the sonication process, aiming to construct a stable suspension, depends on the amount and the concentration of the suspension and the sonication device to be used.

The deposition time should not be less than 10 seconds otherwise it is difficult to control such a rapid process. There is a relation between the electric field intensity and the deposition duration (the higher the intensity goes, the lower the necessary deposition duration becomes). Anyway, the electric field intensity should not exceed 300V/cm.

The organic solvent creating the atmosphere in the desicator during the dehydration process should be the same as the organic solvent used to create the EPD bath.

It is possible to use any other Infra-Red lasers for the sintering process and such as Nd/YAG and diode laser. The laser should be defocused to diameter between 7 to 10 mm and the laser power to be chosen should be between 250 to 2500 watts accordingly. The atmosphere in the chamber, which the samples are placed, to be irradiated, should be of a noble gas. The temperature of the samples in the chamber and during the irradiation process can be controlled by a mounting stage attached to the samples or water-cooling system or any other suitable measure. Alternatively the irradiation can be carried out without a chamber by providing a flow of inert gas on the sample.

It is optional to add a pre-sintering stage. In this stage a sintering process would be performed on the coated samples by either using an oven comprising a protective atmosphere or a laser but in a lower temperature and for a longer time than the laser sintering stage. The purpose of this process is to produce a better adhesion between the Titanium or Titanium alloy and the coating.

### Example 2

Ti-6Al-4V rods diameter 5 mm were mechanically treated and then chemically cleaned. A rod was coated by Electrophertic deposition from a suspension containing 25 -50 g/l of the ceramic powder VITA In-Ceram® ZIRCONIA and additives of binder and surfactant. The coating was obtained by supplying DC current between anode (stainless steel) and cathode (Ti alloy rod). The coating in the “green” state had a thickness of 10-25 microns. The coated samples were irradiated by CO₂ laser at 200-500 watt. The laser beam was scanned upon the coated rod. During laser irradiation a flow of air was maintained continuously and the rod was rotated simultaneously with the laser scan. The laser beam caused both sintering of the coating and building a stable interface between the metal substrate and the ceramic coating to get good adhesion. The hardness of the coating was measured and reached values of 4500-5000 MPa, as compared to a value of about 800 MPa for the “green” coating. A scratch test showed that the treated coating had a good adhesion—no peeling of the coating at the trace edges. The friction coefficient was improved as a result of the laser sintering. A cross section made of the sample was investigated in scanning electron microscope and the microstructure indicated on a good sintering of the laser, good adhesion of the coating to the substrate and a thickness of 20-25 microns.

Deposition Parameters: Field Intensity 15-50 V/cm. Deposition time: 2-60 sec.

### Example 3

Ti-6Al-4V rods diameter 5 mm were mechanically treated and then chemically cleaned. A rod was coated by Electrophertic deposition from a suspension containing 25-50 g/l of the ceramic powder ZIRCONIA TZ-3Y-E manufactured by TOSOH, and additives of binder and surfactant. The coating was obtained by supplying DC current between anode (stainless steel) and cathode (Ti alloy rod). The coating in the “green” state had a thickness of 10-25 microns. The coated samples were irradiated by CO₂ laser at 200-500 watt. The laser beam was scanned upon the coated rod. During laser irradiation a flow of air was maintained continuously and the rod was rotated simultaneously with the laser scan. The laser beam caused both to sintering of the coating and for building a stable interface between the metal substrate and the ceramic coating to get good adhesion. The hardness of the coating was measured and reached values of 2000-2300 MPa, as compared to a value of about 700 MPa for the “green” coating. A scratch test showed that the treated coating had a good adhesion—no peeling of the coating at the trace edges. The friction coefficient was improved as a result of the laser sintering. A cross section made of the sample was investigated in scanning electron microscope and the microstructure indicated on a good sintering of the laser, good adhesion of the coating to the substrate and a thickness of 20-25 microns.

Ceramic powders used:VITA In-Ceram® ZIRCONIA: Mixture of zirconium oxide/aluminum oxide Al2O3 about 67% and t-ZrO2 (Ce-stabilized) about 33% (wt %). ZIRCONIA TZ-3Y-E manufactured by TOSOH, Grain size<0.3 μm: Partially-stabilized Zirconia powder with uniform dispersion of 3% mol % Yttria with sintering temperature of 1350° C.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method for providing ceramic coating on a surface of a metal, comprising:
depositing in electrophresis at least one ceramic layer on the metallic surface; and
sintering said at least one ceramic layer using optical radiation.

2. The method as claimed in claim 1, wherein the metal comprises titanium.

3. The method as claimed in claim l wherein the metal comprises titanium alloy.

4. The method as claimed in claim 1, wherein the surface comprises at least a portion of a surface of an implant.

5. The method as claimed in claim 4, wherein said implant is a dental implant.

6. The method as claimed in claim 5, wherein said portion of the implant body is a portion that is not to be in contact with a bone.

7. The method as claimed in claim 1, wherein the optical irradiation comprises laser radiation.

8. The method as claimed in claim 1, wherein the ceramic layer comprises a mixture with one or more metallic materials.

9. The method as claimed in claim 7, wherein the ceramic coating comprises metal selected from a group of metals consisting nickel, aluminium.

10. An implant device comprising:
an implant body; ceramic coating on at least a portion of the implant.

11. The device of claim 10, wherein the implant body is metallic.

12. The device of claim 10, wherein the implant body is made of titanium.

13. The device of claim 10, wherein said implant is a dental implant.

14. The device of claim 13, wherein said portion of the implant body is a portion that is not to be in contact with a bone.
